(19) United States
(12) Patent Application Publication
(10) Pub. No.: US 2006/0280672 A1
(43) Pub. Date: Dec. 14, 2006

(54) Method for the processing of the used tires

(76) Inventor: Gagik Aharon Vardanyan, Glendale, CA (US)

Correspondence Address: Gagik Vardanyan, 517 Geneva St., Glendale, CA, 91206, US

(21) Appl. No.: 11/147,328

(22) Filed: Jun. 8, 2005

(51) Int. Cl. C09C 1/48

(52) U.S. Cl. 423/449.7

(57) ABSTRACT

In this patent is obtained new method and new device for the processing of the used tiers.

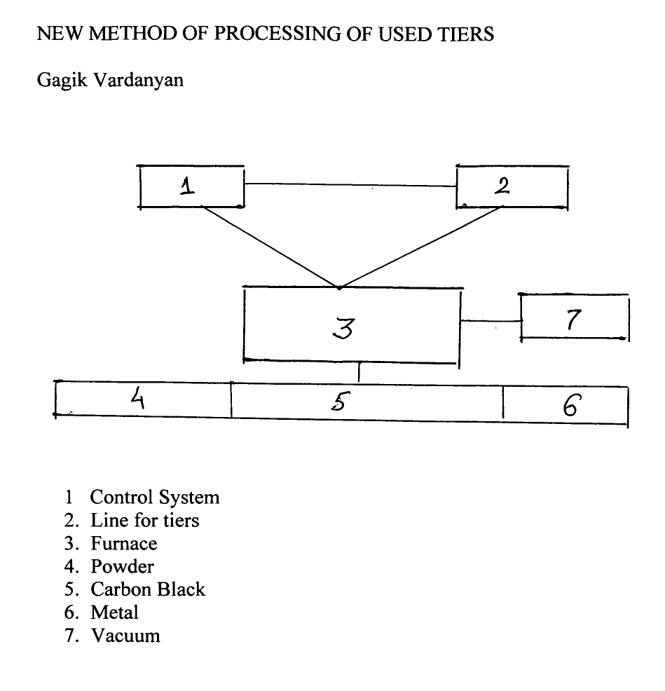

### 1. BACKGROUND OF THE INVENTION

More than 3 billion tiers are dumped worldwide. Only United States dumps more than 300.0000000 tiers every year.

About 80% of tiers made from oil products. An automobile tire contains of energy-equivalent to 2.5 gallons of oil.

The quantity of used automobile tiers collected at dumps or just thrown away is steadily increasing and this is a proof of the week development of the field of processing.

The existing technologies for processing of automobile tiers are disproportionate compared to the huge and ever increasing quantities of raw material and actually they are in a very incipient phase.

The presently used methods for processing of old tiers are:

Mechanical method-impossibility to get a 100% separation between the rubber and the components of tiers, the method is bad for the environment.

Processing of old tiers with ozone-negative ecological effect, dangerous for the people, the inadequate characteristics of form and surface of rubber particles.

Processing of tiers by cryogenic method-increased consume of energy, high overhead expenses and high cost of the liquid nitrogen, high looses.

### 2. BREAF SUMMARY OF INVENTION

The offered new technology will change this situation completely, making the product available, and highly profitable and ecologically clean.

This factory is divided into sectors that will provide operation of processing of used tiers,

This factory, based on the new technology, is composed of main sections:
the power transformer
a furnace
a water cooling system
the magnetic field
the transformer line
the powder packaging system
the metal packaging system
the computerized control system.

One advantage of super inducting heating over other methods is that the heat gradient is produced directly in the workplace.

The offered method has the advantage of perfect separation and cleaning of the metallic cord of automobile tires, which is thus rubber-free and can be used as a valuable metal.

After processing, the rubber material, the obtained powder can be used for the overproduction and manufacturing of the new tire items.

In this method the metallic (about 15%), textile (about 80%) and other (gases) insertions are separated and the optimal processing it is possible to obtain approximately 15 ton/day of metallic cord from 100 tons of tires/day.

Thermodynamic equation, describing the free energy is simply
F=E−TS

Where T—is the temperature and S—is the total entropy of the system.

Here the minimum energy of tire corresponds to an ordered arrangement of the atoms of metallic cord, textile and gases in coordinate space, in which all the particles are at rest at certain equilibrium positions. On the other hand, the entropy S of particles, forming the tire, is different for each component. The equation of state can then be written in the form:
p=(dF/dV)=(dE/dV)−T(dS/dV)

Having the equation of state one can calculate the thermal expansion, thermodynamic function and other characteristics under the variation of temperature, pressure and chemical consistency.

In suggested method the generation of static high pressure are high temperature conditions are based on the changes of physical phases and characteristics in the presence of magnetic field.

The apparatus designed for this purpose easy to use and ecologically absolutely clean. Pressure is generated by using system of devices. Temperature is generated be passing a low voltage, high current signal through a graphite core.

The fundamental differences in entropies of each components of tire are the base of this new method of separation of components and processing.

### 3. DETAILED DESCREPTION OF THE INVENTION

Super induction process is the process of an electricity conducting object immersed in a varying magnetic field.

The object not is a magnetic material. The object has electrical conductivity.

Non-conductivity material is possible in certain conditions.

Eddy current is electrical current induced by transformer action in the material.

Eddy current losses occur in and material in a varying magnetic field.

Eddy current losses caused heating any material in varying magnetic field.

Transformer coil.

Eddy current losses are important in the super induction furnaces.

Induced current due to the changing magnetic field of the coil causes heating.

where is consumed in a resistance when current flows through the conduction.

P=I²R—power is the rate at which electrical energy is transformed into heat energy.
P—is power,
I—is the current in amperes,
R—is the resistance in ohms.

Hysterics (H=mM*).
m—is the magnetization.

M*—is the changing magnetic field.

A reversal of magnetic field requires energy.

The energy converts to heat.

The heat generated by hysterics helps to increase the T of material.

The rate of expenditure of power increases with an increased rate of frequency.

Curie T is important for super-inducting process.

The super conduction furnace is composed of crucible, which is surrounded by a water-cooled helical coil,

Connected to a source of alternating current.

The alternating current applied to the coil produces varying magnetic field, which is concentrated within the helical coil.

This magnetic field interacting with super-inducting magnetic field.

Resulting magnetic field passing through the charge induces an alternating current in the charge.

The current circulating in the charge produces I R losses which heat the charge.

1. New device for processing of used tiers into powder based on the new “super-conducting” method.

2. Effective method for carbon black production.
